(19) United States
(12) Patent Application Publication
(10) Pub. No.: US 2024/0428349 A1
(43) Pub. Date: Dec. 26, 2024

(54) DATABASE SYSTEM FOR MANAGING ASSETS OF AN OIL AND GAS OPERATION WITHIN SET DISTURBANCE LIMITS OF A GEOSPATIAL LOCATION

(71) Applicant: EcoPoint, Inc., Rifle, CO (US)

(72) Inventors: Michael CLANCY, Rifle, CO (US); Michael DOOLEN, Lincolnville, ME (US)

(73) Assignee: EcoPoint, Inc., Rifle, CO (US)

(21) Appl. No.: 18/732,571

(22) Filed: Jun. 3, 2024

Related U.S. Application Data
(60) Provisional application No. 63/522,719, filed on Jun. 22, 2023.

(51) Int. Cl. G06Q 50/06; G06F 3/0481; G06F 3/0482; G06F 16/29; G06Q 10/20

(52) U.S. Cl. CPC G06Q 50/06; G06F 3/0481; G06F 16/29; G06Q 10/20; G06F 3/0482

(57) ABSTRACT

A database management system for managing assets of an oil and gas operation includes a server in data communication with a computing device over a network. The computing device includes an interactive user interface. Memory is stored in the server and accessible by the computing device. Asset data is stored in the memory and is retrievable by the computing device. The asset data includes geospatial information defining at least one disturbance site and spatial feature information defining one or more oil and gas assets located within the disturbance site. The interactive user interface displays a digital twin of the disturbance site based on the asset data.

### RELATED APPLICATIONS

The present application claims priority to U.S. Provisional Application 63/522,719 filed Jun. 22, 2023, the contents of which are incorporated herein by reference.

### BACKGROUND OF THE INVENTION

### Field of the Invention

The present invention relates generally to database systems and processes for constructing those databases, and more specifically to database management systems useful in the oil and gas industry for mapping and tracking spatial and tabular features within disturbance limits of a geospatial location. In another aspect, the invention relates to user interfaces for database management systems for mapping and tracking spatial and tabular features within set disturbance limits of a geographic location.

### Description of Related Art

Oil and gas are commodities that have become essential to the functioning of the modern world. Whether it be gasoline refined from extracted oil to power a vehicle or natural gas being used to heat a home or other building, the oil and gas industry plays a crucial role for the supply and consumption of energy.

Globally, the oil and gas industry has a market size of roughly $5.0 trillion as of 2022. The oil and gas industry in the United States accounts for over $800 billion of that global market. The economic impact of the oil and gas industry has direct and indirect effects on world economy because almost every sector of the economy directly or indirectly utilizes some product of the oil and gas industry.

Operations of the oil and gas industry have a significant environmental impact. To extract the oil and gas from the earth, an oil and gas operator (hereinafter, just “operator”) must identify a geographic area where the commodities are likely to be located, and then construct drilling and extraction apparatus to acquire the commodities in an unrefined state. The real world process for extracting oil and gas is, however, much more complicated than merely identifying a location and drilling a well. There are extensive federal, state, and local laws and regulations in place that impose significant burdens on an operator during all phases of construction and extraction.

A typical lifespan of an oil well, from the earliest stages of planning the well to the final stage of plugging the well and restoring the land, is generally twenty to thirty years. During this entire lifespan, most every event that occurs at the disturbance site of the well location, as well as every operation and maintenance event at the well itself, needs to be documented and recorded to ensure compliance with the applicable regulations. This documentary burden applies equally to all other infrastructure constructed on site, and to any other physical changes made to the land, such as construction of easements, berms, or excavation of a pond or reserve pit. In addition to documenting physical infrastructure at the disturbance site, the operator will also be responsible for documenting certain activities that occur at the site, such as a chemical leak or oil spill, along with remedial actions taken in response.

Maintenance and repair of the site infrastructure is another ongoing burden for operators of oil and gas wells. Oil and Gas operations require cooperation of many systems and components to ensure proper performance of all aspects of the operation. As with any electro-mechanical system, however, an operator must periodically repair or replace various components to maintain the plant in working order. Whether the maintenance or repair is routine or in response to some unexpected component failure, the procedures undertaken must be documented and recorded to ensure regulatory compliance.

Further, any reclamation activity that takes place at the Oil and Gas location must also be documented and recorded, including activities undertaken to clean an oil spill or other chemical leak. Reclamation activities may also include all actions taken to reclaim the land to the condition it was in prior to the commencement of the oil and gas operations, such as plugging the well, removing all infrastructure from the site, replacing and recontouring sub surface and top soil, and revegetating the location.

Historically, data that must be collected by operators to respond to regulatory reporting requirements is fragmented, having been stored across numerous different departments of one or more prior operators. The fragmentation of information is often exacerbated where third party contractors are hired to handle specific jobs at the Oil and Gas location and file specific regulatory applications or reports. Such fragmentation results in limited availability of relevant data for field use, which can limit a field operator's productivity and lead to work delays and other inefficiencies.

The historical decentralization and fragmentation of data pertaining to the Oil and Gas location site leads to an overall increase in costs associated with managing and maintaining that operation. Further, this fragmentation of data can lead to an increased likelihood of relevant data being lost or destroyed over the lifetime of the operation.

It would be desirable, therefore, to provide an information management system that compiles all historical information relevant to an oil and gas operation for customized retrieval from a centralized location accessible to the operator.

### SUMMARY OF THE INVENTION

The above problems are overcome according to the present invention. A database according to the present invention consolidates traditionally segmented information into a common location and provides user friendly access to such information. Further, a database management system according to the present invention allows a user to readily access and digest pertinent information regarding the assets of the oil and gas operation. The database management system can reduce an operator's regulatory reporting burden by increasing efficiency to access all the necessary information. The database management system may also include functionalities to automatically produce reports based on regulations applicable to a given disturbance site.

In a first embodiment of the invention, a database management system for the assets of an oil and gas operation includes a server in data communication with a computing device over a network. The computing device includes an interactive user interface. Memory is stored in the server and accessible by the computing device. Asset data is stored in the memory and is retrievable by the computing device. The asset data includes geospatial information defining at least one disturbance site and spatial feature information representing one or more assets located within the disturbance site. The user interface generates a digital twin of the disturbance site, including mapping all assets in the appropriate location.

In some embodiments, the interactive user interface has a display window and a tab window. The display window is automatically populated with the digital twin of the disturbance site. The system categorizes the spatial feature information by asset type and populates the tab window with the asset type categories as selectable categories. Selection of any one of the selectable categories causes the display window to automatically update the digital twin representing the disturbance site with an asset layer, where the asset layer includes all assets falling within the selected asset category. Where multiple asset categories are selected, the display window maps an asset layer for each selected asset category. The multiple asset layers are automatically combined into a common layer so the display window appears to be populated with a single asset layer.

In more elaborate embodiments of the invention, a regulatory module may also be stored in the memory and accessible by the computing device. The regulatory module is engineered to generate an output based on the asset data and display that output in the interactive user interface. The regulatory module may include a means for filtering regulations based on location. The regulatory filtering means is engineered to interpret the geospatial information to determine the precise location of the disturbance site. The regulatory filtering means thereafter pulls from the memory regulations only applicable to that precise location. In such embodiments, the asset data may also include attribute information representing the one or more assets within the disturbance site. The attribute information corresponds to nonspatial features or aspects of the one or more assets. The regulatory module may interpret the attribute information to produce an output regarding one or more of the assets. The memory may also store tabular feature information that may be linked to the spatial feature information of one or more assets. In some embodiments, any output from the regulatory module is stored as tabular information and is linked to the spatial feature information. The interactive user interface may display the output of the regulatory module as an icon in the display window that is mapped over the asset to which the output has been linked.

In further embodiments, the asset data further includes attribute information representing nonspatial features of the one or more assets at the disturbance site. The system may include an operational module stored in the memory and accessible by the computing device. Preferably, the operational module is engineered to interpret the attribute information of the one or more assets to generate an operator output. In some embodiments, the operator output may be a maintenance schedule for a subset of assets that possess common attribute information. The operator output is generated based on the common attribute information among the subset of assets.

In more elaborate embodiments of the invention, there may be a plurality of asset data stored in the memory, where each asset datum includes geospatial information defining a unique disturbance site and spatial feature information representing one or more assets located within the unique disturbance site. In some embodiments, the interactive user interface may include an operator display that generates a digital twin for each unique disturbance site. Each digital twin may be selectable in the operator display so that upon selection of one digital twin, the user interface will only display that selected digital twin.

In some embodiments, the server may be a tiered server, where each tier of the server includes a means for authenticating a user which will limit the user's access to manipulate the asset data.

These and other features of the disclosed invention will become apparent to the skilled artisan in view of the following disclosure.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a block diagram of an example of the network architecture for a database management system according to the present invention.

FIG. 2 is a first view of an example of an asset data structure according to the present invention.

FIG. 3 is a simplified view of an example of an asset data structure according to the present invention.

FIG. 4 is a first map view, according to one embodiment of the present invention, of the data structure detailed in FIG. 3.

FIGS. 5a and 5b are views of an embodiment of an interactive user interface according to the present invention.

FIGS. 6a and 6b are alternative views of an embodiment of an interactive user interface according to the present invention.

FIG. 7 is a view of an example of a secondary display screen accessible via the interactive user interface according to the present invention.

FIG. 8 is a view of an attachment that may be accessed through the interactive user interface.

FIG. 9 is a first view of an embodiment of an operator interface according to the present invention.

FIG. 10 is a first view of an embodiment of an assessment display interface that is accessible via the operator interface of FIG. 9 according to the present invention.

FIG. 11 is an alternative view of the assessment display interface of FIG. 10.

FIG. 12 is a further alternative view of the assessment display interface of FIG. 10.

FIG. 13 is a first view of an embodiment of an assignment interface accessible via the operator interface of FIG. 9 according to the present invention.

### DETAILED DESCRIPTION OF THE INVENTION

The present disclosure is directed generally to a database management system and associated user interface related to a specific geographic location. The database generates a digital twin of all spatial features that are located within the disturbance site at a geographic location and is further crosslinked with one or more tabular features of the disturbance site. As used herein, the term “spatial feature” is understood to mean any physical alteration to the land. Therefore, “spatial feature” includes all physical infrastructure installed at the geospatial location but also includes things such as construction of a berm or reservoir or even an access road. A spatial feature is also understood to include reclamation activities, such as cleaning of a spill and information pertaining to the spill itself, e.g., when and precisely where the spill occurred, how much and what was spilled, etc. The term “tabular feature” is to be understood to mean all other information pertaining to intangible aspects of the operation that can be related back to one or more spatial features. For example, if the spatial feature is a berm constructed at the disturbance site, the tabular feature can be a qualitative assessment of that berm, e.g., how well the berm maintained its structure, grass and/or weed growth, etc. Other types of tabular features may include maintenance schedules for specific spatial features (e.g., required maintenance on a specific type of valve) or scheduled inspections for the spatial features or the overall disturbance site. Further, regulatory reports and other information that may be required by law or regulation would be considered tabular features and may be crosslinked back to the spatial feature or features requiring reporting. Together, spatial features and tabular features may be described broadly as asset data.

In another aspect of the inventive concepts disclosed herein, the geospatial database has an interactive user interface, which allows the end user access to the digital twin of the disturbance site and provides the user with tools useful for digesting and interacting with the database. Data representing all the spatial features is organized by category. Data representing tabular features may be crosslinked to related spatial feature data. The organized data can be presented in tabular format where each tab corresponds to a spatial or tabular feature within the limits of disturbance at the disturbance site. The user interface has means to filter and query the tabular data such that only the selected data is presented in the digital twin. These and other aspects of the interactive user interface and digital twin model will be discussed in further detail below.

The geospatial database system and associated methods of construction disclosed herein can be useful throughout the lifetime of an oil and gas operation at the disturbance site. The geospatial database is constructed in a bottom-up procedure where the first step is to identify the geographic location and set the disturbance limits defining the disturbance site.

The geospatial database can be constructed from historical data relating to a disturbance site that already has an existing oil and gas operation located thereon. Relevant spatial data may be collected from the various departments within an operator's organization. Any spatial data that has become lost or is otherwise incomplete can be supplemented with information obtained from a physical inspection of the disturbance site or otherwise obtained from third parties that may possess the relevant data. Physical inspection of the disturbance site can be provided by a person physically present at the location to collect and record relevant data, by aerial footage or still images of the location collected through use of a drone with video and image capturing capabilities, and by use of satellite imagery of the location. Video and imaging of the disturbance site may also be accomplished terrestrially using image capturing devices, e.g., drone or hand-held video capturing devices. Global Positioning System (“GPS”) systems may also be used to collect certain information about the disturbance site, e.g., longitude and latitude information and other standard geographic information. A combination of collection methods might provide the most comprehensive data collection of an existing disturbance site. Further supplementation of historical data may still be necessary and can be accomplished by analyzing any other available data corresponding to the disturbance site, which may include historical records held by one or more regulatory agencies.

Once the existing spatial data relating to the disturbance site has been collected, the data is categorized and organized according to various characteristics of the data. At a high level, spatial data can be categorized according to the type of feature to which the data corresponds. For example, spatial data may be categorized as “infrastructure,” “lines” or “well machinery.” Other categories may also be applied to the data depending on the type of operation and type of assets being utilized at the disturbance site. The spatial feature data consists of geospatial information and attribute information for each corresponding asset found at the disturbance site. The geospatial information describes the precise location of the spatial feature within the disturbance site, e.g., a containment feature labeled “A” may be located in the northwest corner of disturbance site. The geospatial information also defines the spatial feature data as either a point, line, or polygon, which provides shape to the feature in an end user's display, e.g., containment feature A may be shaped as a polygon. Attribute information describes the characteristics of the spatial feature and can be used to further subcategorize spatial data within an overarching category, e.g., containment feature A may be a ‘retention pond’ with a radius of thirty feet, a depth of fifteen feet and a liner made from poly-vinyl chloride (PVC). Thus, the geospatial information for each spatial feature data entry defines the precise location of the feature in the disturbance site that corresponds to the real-world location of that feature. The geospatial information further provides shape to the feature, and the attribute information provides details on the underlying characteristics of that spatial feature.

Tabular feature data may include only attribute information describing the characteristics of that data. There is no geospatial information for tabular feature data, rather, tabular feature data can be crosslinked to one or more spatial features in the overall data structure. Further, multiple tabular feature data entries can be crosslinked to a single spatial feature in the overall data structure. For example, a qualitative assessment of grass and weed growth around containment features may be crosslinked to all the containment features at a disturbance site: e.g., the retention pond (containment feature A) from the above example and a berm (containment feature B) constructed near the pond. A second qualitative assessment on the effectiveness of water retention in the pond can also be crosslinked to only the retention pond (containment feature A). Other examples can include tabular feature data detailing required maintenance on certain components of a spatial feature. Such “maintenance” tabular data can be crosslinked to each spatial feature that has the specific component with the required maintenance at a disturbance site. Numerous other examples of the interaction between spatial and tabular data features will become apparent to those skilled in the art in view of the remaining discussion.

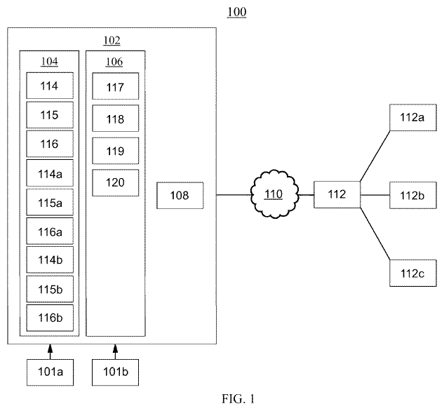

Turning to the figures, FIG. 1 is a high level block diagram illustrating an example of the network architecture of a geospatial database system 100 according to one aspect of the present invention. The geospatial database system 100 has a primary server 102 connected over a network 110 to one or more client devices (or simply clients) 112a, 112b, 112c. Clients 112a, 112b, 112c may be referred to collectively or generically herein as client 112. The primary server 102 can be a cloud based server, i.e., a server that is operated and maintained in the cloud environment and invisible to the client. For example, the primary server 102 may be a cloud based server maintained through Amazon Web Services®. Alternatively, the primary server 102 may be a local server connected through a network. The client 112a may include a web browser installed on a desktop computer or mobile phone for accessing the Internet. Client 112b may be a desktop or handheld computer or smartphone running an application configured to communicate with the server 102. Client 112c may be any other means by which the primary server 102 can access, or be accessed by, a device over the network 110. Generally speaking, clients 112a-112c allow an operator and/or field worker to access the geospatial database system remotely while performing field work at a disturbance site. Access to the geospatial database system through clients 112a-112c is not limited to field work but is also useful in performing editing and analytics work from other locations such as an office. As will be explained in more detail below, the client 112a-112c each display a unique interactive user interface that has a plurality of different functionalities and can be customized to an operator's specific need at a specific time.

In some instances, a field worker using a remote client 112 to access server 102, such as via a mobile phone application, can “check out” relevant data from the geospatial database system 100 to have a disconnected workflow environment which allows the operator to update and edit the data while working remotely in the field. This feature of the system can be particularly useful when the disturbance site is in a remote location with limited or no network connectivity. The updated data is thereafter checked back into the system 100 when connectivity has returned and the system is automatically updated with the new data entries.

Data entry into the geospatial database system 100 can be inputted through direct data entries 101a and through third-party indirect data entries 101b. Direct data entries 101a can be historical information that an operator has access to that relates to the disturbance site as well as previous and future site assessments and/or inspections. Satellite and other types of aerial imagery of the disturbance site can also be input to the system 100 through direct data entry 101a. Indirect data entries 101b may be generated from an automated capture of information from third-party sources that are publicly available or otherwise accessible by the system. For example, weather data pertaining to the geospatial location may be pulled from third-party weather services and uploaded into the system 100 automatically. Throughout the life of an Oil and Gas operation at a given disturbance site, the system 100 will be continuously updated through both direct data entries 101a and indirect data entries 101b.

In preferred embodiments, the primary server 102 may have three tiers. For example, the primary server 102 may have a geodata tier 104, a services tier 106, and a portal tier 108. Each tier 104, 106 and 108 of the primary server 102 stores distinct information and functionalities to allow the multiple tiers 104, 106 and 108 to cooperate to achieve the desired functionality of the geospatial database system 100 including visual presentation of information to the clients 112. The portal tier 108 provides a main communication link between the primary server 102 and the client users 112 over the network 110. The tiered nature of the primary server 102 also increases security of the database system 100 by ensuring that a user may only be permitted access to approved data.

Within geodata tier 104 there is at least one geodatabase. Preferably, there is a plurality of geodatabases 114a-114b where each geodatabase 114a, 114b corresponds to a specific operator and all disturbance sites held by that operator. Note, FIG. 1 only illustrates two unique geodatabases 114a and 114b but it is understood that a geodatabase is stored in the geospatial database system 100 for each operator holding a unique disturbance site. Herein, geodatabase 114 may refer collectively or generically to one or more operators' geodatabases within geodata tier 104.

The geodatabase 114 may be a relational database, e.g., a PostgreSQL relational database, that functions with a post geographic information system (PostGIS) extension 117, such as Esri's ArcSDE extension that operates in the ArcGIS environment. The PostGIS extension 117 is stored within the services tier 106 of the primary server 102. The geodatabases 114 are relational databases that store and organize the spatial feature data and tabular feature data in such a manner that each geodatabase 114 is a digital twin of the disturbance site. The geodatabases 114 are spatially enabled by the PostGIS extension 117 of the services tier 104 such that the client users 112 are served up with an interactive digital map representing the disturbance site with all spatial features mapped thereon.

The geodata tier 104 also stores imagery, such as drone or satellite imagery, of the disturbance site as tile cache data and raster data. Each geodatabase 114a, 114b has its own tile cache 115a, 115b and raster data 116a, 116b of imagery pertaining to a disturbance site of that operator. As the number of geodatabases 114 stored in the geodata tier 104 increases, tile cache data 115 and raster data 116 entries similarly increases. Each tile cache data 115 and raster data 116 is unique to the corresponding geodatabase 114.

As used herein, tile cache 115 may refer collectively or generically to one or more tile cache date entries pertaining to one or more geodatabases 114. Similarly, raster data 116 may refer collectively or generically to one or more raster data entries pertaining to one or more geodatabases 114.

The services tier 106 stores additional functionalities that interact with data stored in the geodata tier 104. For example, the additional functionalities may include a regulatory module 118, an environmental module 119, and an operational module 120 stored in the services tier 106. Each of these modules 118, 119 and 120 access the geodata tier 104 via the PostGIS extension 117 to maintain spatial enablement of the data being accessed by any one or more of the modules.

As stated at the outset, oil and gas operations are subjected to extensive regulations imposed by local, state and federal governmental agencies. These regulations can vary from location to location. Further, regulations are continually evolving and changing overtime. Thus, in one example of the regulatory module 118, the module can pull the regulations applicable to a specific disturbance site by interpreting the geospatial data to determine the precise location of the disturbance site, e.g., disturbance site located in county A in state B on federal land. A user can thereafter select a particular regulation that governs compliance for that particular location and the system 100 can produce the required report with the relevant data from that disturbance site relating to that same regulation. In preferred implementations, the system 100 can automatically produce the required report by pre-populating relevant or required entries with the relevant data. For instance, operations in some states on federal land are required to periodically produce specific maps of the disturbance site that have been signed and verified as accurate by the site surveyor or engineer. A user can select the applicable regulation through an interface with the regulatory module 118 in the system 100 and the module can produce the required map with the appropriate spatial features mapped thereon for the surveyor/engineer to review and approve. If the surveyor/engineer is permitted access to the system 100, that user can electronically sign the map or, where they do not have access to the system, a hardcopy of the map can be printed and physically signed and thereafter reuploaded to the system. Updating the database system 100 with the completed site map will similarly update the regulatory module 118 so that it can predicate the next instance the same regulation will be implicated and require compliance. In this manner, the module 118 can dynamically track compliance at a specific disturbance site and automatically update the database system 100 with the necessary information. Numerous other possibilities of the functionality of the regulatory module 118 are also present. In essence, the output from the regulatory module 118 is dependent on the disturbance site location and the regulation(s) selected by the user for compliance. Preferably, the regulatory module 118 will only present a user with the option to select regulations that are applicable to the specific disturbance site based on the geospatial information and filter out all other regulations that do not apply based on the location information.

In similar fashion, the operational module 120 can be used to produce reports detailing any required or suggested maintenance schedules specific to that disturbance site or any other operational need found at the site. The operational module 120 can work in conjunction with the regulatory module 118 and the environmental module 119 to produce a report detailing maintenance or other operational needs that may be required by regulation or to address an environmental issue, such as a spill caused by a faulty mechanical component, at the site. The operational module 120 interprets the attribute information for specific spatial features to produce the outputted report. Information such as manufacturer's suggested maintenance, last maintenance performance date, last inspection date, replacement parts and any other information pertaining to that spatial feature can be stored as attribute information in the geodatabase 114 of the system 100 for the operational module 120 to digest and interpret in producing various reports. For instance, manufacturer A may suggest performance of routine maintenance every six to nine months on mechanical component B. This information is stored in geodatabase 114 as attribute information for each occurrence of mechanical component B in the geodatabase. The operational module 120 interprets this attribute information for each instance of mechanical component B and provides a report detailing the suggested maintenance dates based on the last maintenance performance date and/or the date of installation. When an operator or field worker performs the maintenance, the performance date can be uploaded into the geodatabase for each mechanical component B that maintenance was performed on at that time and saved as attribute information for that component. The operational module 120 can thereafter interpret the updated geodatabase 114 to produce an updated report detailing the next suggested maintenance dates.

In a second example of the operational module 120, a field worker may identify a specific valve, e.g., valve X, that is not operating properly. The field worker can identify the spatial feature corresponding to valve X and tag it with an “operational need” that will identify the required work and provide details on the project for the operational module 120. The “operational need” can be stored as attribute information for the spatial feature data entry of valve X. The operational module 120 can interpret the attribute information and, based on the details provided by the field worker, produce the output report detailing the work that is needed to remedy the faulty valve X. The report may be stored in the geodatabase 114 as a tabular feature that is crosslinked to the spatial feature entry for valve X. A second field worker can be assigned to the operational need and can view the report outputted from the operational module 120 and accomplish the required tasks, e.g., fix or replace valve X. Upon completion of the task, the second field worker can upload such information into the system causing the operational module 120 to resolve the identified task.

The environmental module 119 can produce a variety of reports depending on the type of activity undertaken. The environmental module 119 can be useful throughout the lifetime of an operation at a disturbance site and particularly useful at the end of the life of that operation. For example, during the lifetime of an operation, a spill might occur at the disturbance site which requires specific cleanup activities to be undertaken. The environmental module 119 can produce a report of the spill, set the necessary steps to ensure the cleanup is accomplished in accordance with any applicable regulations and then produce a final report to outline the necessary details regarding the spill and cleanup activities. The environmental module 119 can also be used at the end of the life of a disturbance site. In such case, the environmental module 119 can outline all steps necessary to return the disturbance site back to its original state and produce a final report detailing the final reclamation activities undertaken at the disturbance site. The environmental module 119 will interact with and cooperate with the remaining modules to include any other information in the final report that may be required by law or regulation. The interaction and cooperation between the modules is not limited to this final scenario but rather the modules continuously interact and cooperate together throughout all uses of the system 100.

Other examples of the environmental module 119 can include required inspections as well as qualitative and quantitative assessments of activities undertaken at the operation site. For instance, an operation may be required by regulation to have means to retain storm water and there may be mandatory scheduled inspections to ensure compliance with those regulations. In one output from the environmental module 119 an inspection schedule can be produced for storm water retention. Further, the environmental module 119 may simultaneously tag any other aspects of the operation at that given disturbance site that may also be up for a mandatory inspection around the same time as the storm water retention inspection is scheduled. In this manner, the module 119 may be used to inform the operator of all inspection needs at a given disturbance site that are required by regulation to be completed within a specific time frame. In this use case, the environmental module 119 will interface with the regulatory module 118 to identify any required inspection timelines for the disturbance site as a whole and for individual components utilized at the site.

In another aspect, the environmental module 119 may be used to produce a qualitative and quantitative assessment of the storm water retention activities undertaken at the site. This may include an assessment of the quantity of water retained versus the expected retention and the durability of the retention means, e.g., whether the retention pond maintained its shape or has begun eroding or degrading to a point that maintenance is required. The water retention assessment example may involve an automated analysis of the tile cache 115 and raster data 116 of the disturbance site as a whole and for the specific spatial feature or spatial features being assessed. If a maintenance need is identified, the environmental module 119 can crosslink with the operational module 120 to identify the maintenance need and produce a responsive report for a field worker to accomplish the task. The report is stored as a tabular feature data entry that is crosslinked with the relevant spatial feature data entry or entries in the geodatabase 114 of the system 100.

The modules 118, 119 and 120 work together through the PostGIS extension 117 to generate expert system 100. The expert system 100 can automatically produce reports responsive to a user's input and populate those reports with the requisite information from one of the geodatabases 114. The modules 118-120 cooperate together to pull all information relevant to a user's input and compile it into the outputted report. In one example, input 101a may be a complete inspection report of the disturbance site that identifies excessive weed growth in one area, failing berm in another area, and valve X on line A has a leak. The expert system 100 interprets this inspection report (i.e., direct data entry 101a) so that each applicable module is activated and a proper report is generated. Continuing with this example, the system 100 may activate the operational module 120 to tag the specific area identified with excessive weed growth with a maintenance need and to tag the specific berm with a separate maintenance need. The regulatory module 118 is similarly activated to ensure performance of any maintenance may be done in accordance with the applicable regulations. The system 100 may activate all three modules 118-120 when considering valve X leaking on line A. The environmental module 119 may cooperate with the regulatory module 118 to generate a report detailing the necessary cleanup procedures while the operational module 120 in conjunction with the regulatory module may generate a report detailing the maintenance and repair needs to fix the leak.

In a further example, if a spill occurs at the site, the spill must be cleaned and the land restored. However, specifics of the cleanup process may be required by regulation and certain details regarding the reclamation activities taken may be required in a final report. The expert system 100 will pull the relevant information from the regulatory module 118 and the environmental module 119 so that the operator can quickly and efficiently satisfy both reclamation and regulatory reporting requirements. Additionally, where the spill may have been caused by a mechanical failure, the expert system 100 can pull information from the operational module 120 that can be useful in identifying and fixing the cause of the spill and include such information in the generated report.

There are many more examples of the cooperation and interaction of the various modules 118-120 that result in the expert system 100 and can save an operator significant time and resources in managing the assets of an operation. A further benefit of the expert system 100 is the automatic generation and storage of a historic trail of the activities undertaken at a given disturbance site, which historic trial may also be required in some regulatory submissions. For instance, the system 100 will store and track the initial date entry 101 identifying any need at the disturbance site (e.g., historical record of who conducted a site inspection, on what date and at what time), store and track the output from the system in response to the initial data entry (e.g., report assigned to specific worker to address one or more of the specific identified needs at the disturbance site), and store and track the final completion of the work (e.g., final input into the system closing out the work assignment will track specific field worker who completed the work on a specific date and time). This historic trail is generated as a byproduct of the system 100.

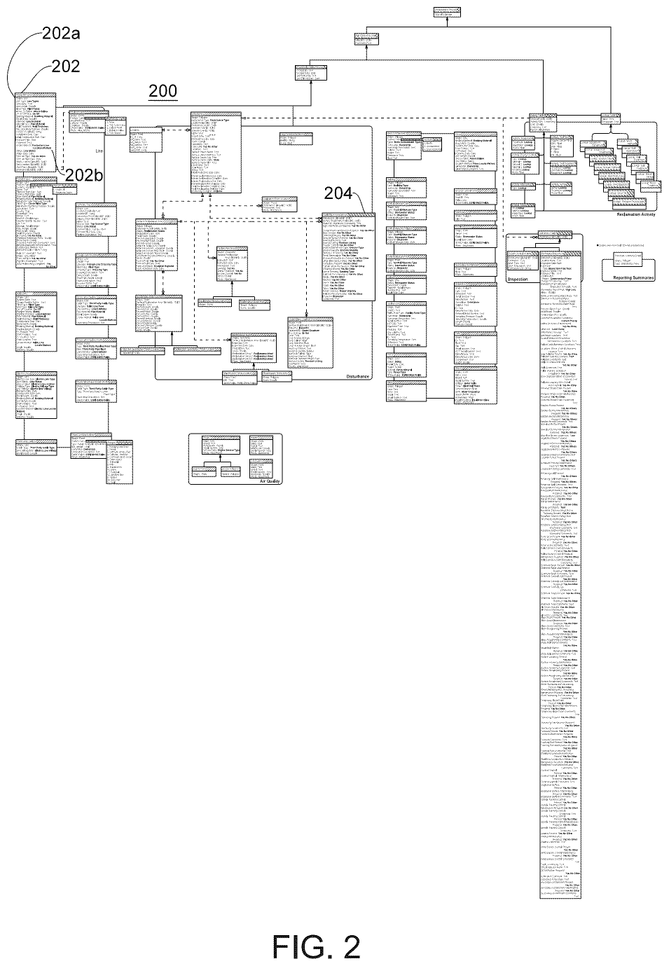

FIG. 2 is a diagram of one example of the asset data structure stored in the geodatabase 114 of the system. Each spatial data entry 202 comprises geospatial information 202a and attribute information 202b, as explained above and detailed further below. The geospatial information 202a of each data entry 202 can be interpreted by the PostGIS extension 117 of the expert system 100 to accurately place a corresponding spatial feature on the map 400 served up to the end user through the interactive user interface 500. The PostGIS extension 117 can interpret shape information stored as part of the geospatial information 202a to provide geometry to the mapped feature. The attribute information 202b can interface with modules 118 to 120 to produce reports responsive to a user query.

Tabular data entries 204 are also contained within the asset data 200. The tabular data entries 204 are crosslinked with one or more specific spatial data entries 202 such that the tabular data can be tied to a specific spatial feature. For instance, a tabular data entry 204 can represent a qualitative assessment of the grass planted on a berm, e.g., an assessment report output from the environmental module 119 and tied to the berm-specific spatial data entry 202. The qualitative assessment is related to that spatial feature, e.g., the berm, in the abstract sense that the assessment is on the quality of grass planted at the berm. However, the assessment may represent an analysis of multiple disturbance sites within a common geospatial location that have used a common grass type on berm constructions. Thus, the tabular data entries 204, while tied to at least one spatial data entry 202 in one data structure 200, can also be crosslinked across multiple data structures of multiple geodatabases 114 representing multiple distinct disturbance sites. Alternatively, the assessment may be conducted at a single disturbance site that has multiple containment features with a common grass type, e.g., berms with grass Y. In such an example, each of the containment features, e.g., each independent berm, has a unique geospatial location within the site but a common feature has been assessed among them, e.g., the quality of grass Y growth. Thus, the tabular data entries 204 can also be crosslinked to multiple spatial features 202 within the same data structure 200.

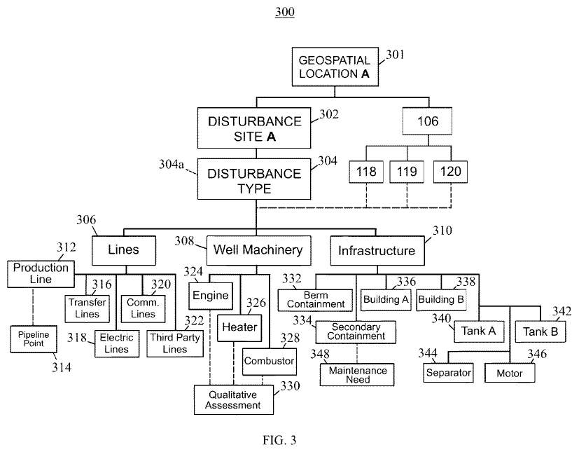

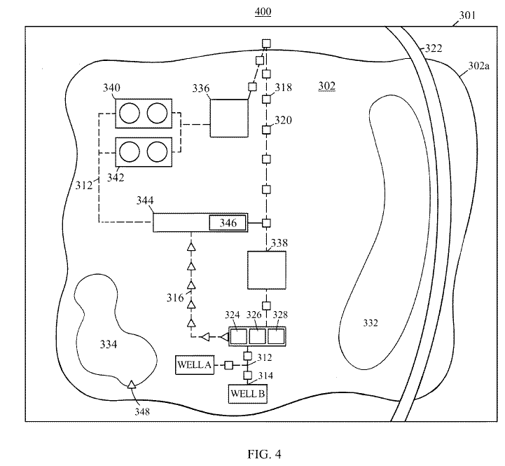

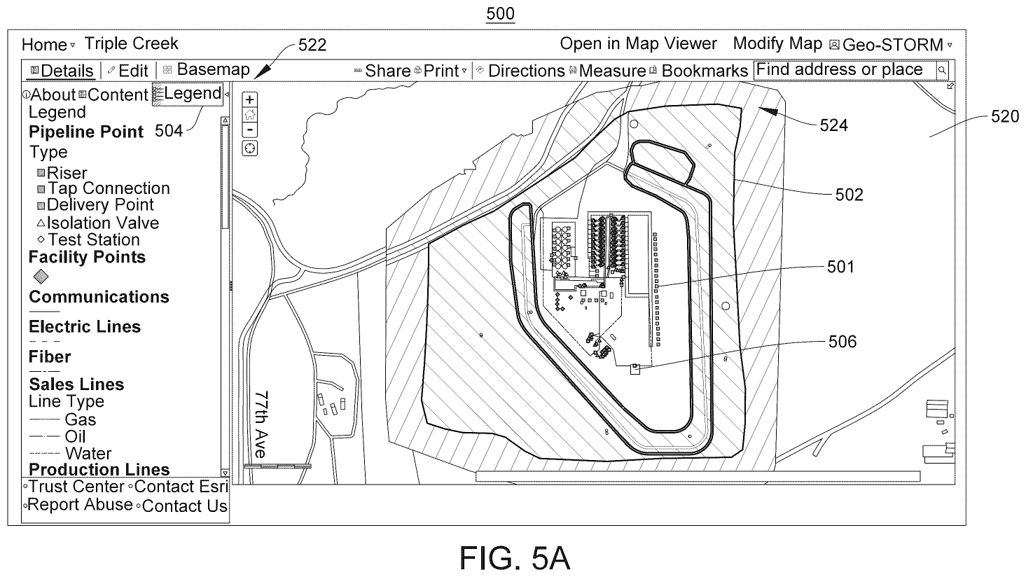

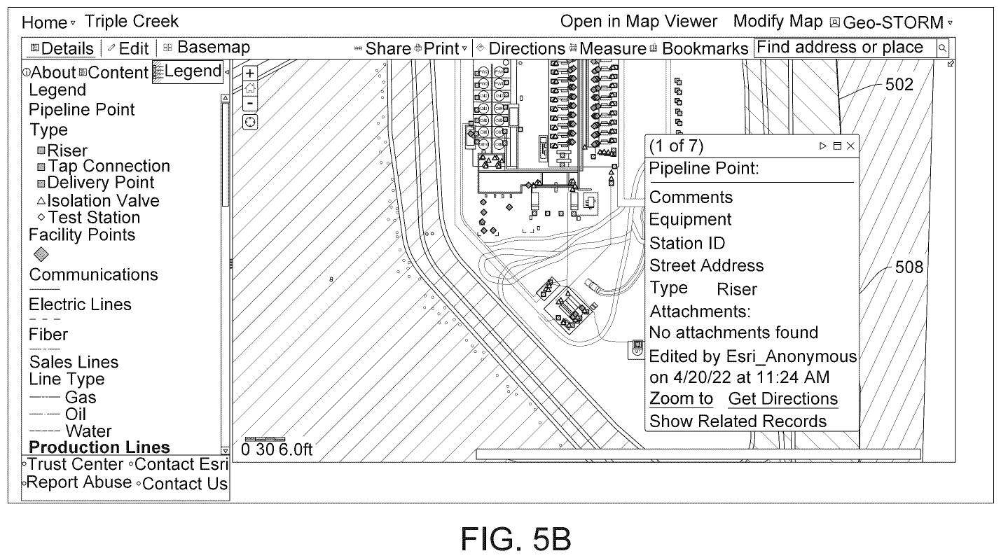

For purposes of discussion and the sake of clarity, FIG. 3 is a simplified version of FIG. 2, illustrating an asset data structure 300 and the interaction with modules 118-120 in expert system 100. FIG. 4 is an illustrative example of a map 400 of the asset data structure 300 of FIG. 3 that can populate a display window as part of the interactive user interface 500 (FIG. 5). The map 400 is one option in which an end-user can interface with the asset data through the expert system 100, as will be explained in more detail below. The map 400 is a digital twin of the disturbance site from the real world, e.g., the map 400 replicates the real world oil and gas operation at a given disturbance site, with the oil and gas assets mapped according to the real world locations thereof.

At the highest level, the asset data structure 300 defines a geospatial location A 301. Depending on the operator and specific uses of expert system 100, the geospatial location 301 can define a state only or a specific city or county within the state. Thus, geospatial information 202a of the geospatial location 301 can be used by the various modules 118-120 to create a backdrop on which the geodatabase 114 operates. For instance, if the geospatial information 202a for geospatial location 301 defines the site as being in county A in Colorado, the regulatory module 118 can automatically pull the federal regulations pertaining to the operation as well as any specific state and county regulations relevant to that location. In this scenario, the regulatory module 118 can ignore other state-specific regulations, for example, those pertaining to Texas, since the operation is located only in Colorado and thus only subjected to Colorado law in addition to federal law. Similarly, the regulatory module 118, based on the geospatial location 301, knows only to pull regulations applicable to county A and ignore other Colorado county regulations. Thus, from the start, the geospatial location 301 provides the backdrop with which the modules 118-120 can begin to pull information relevant to that specific location only for the system 100 to work with and use. Alternatively, where an operator has multiple operations within a single state, the geospatial location 301 may be set to the state level, e.g., Texas. In this manner, the regulatory module 118 can pull all Texas-specific and federal regulations to create the backdrop. Thereafter, the geospatial information for each specific disturbance site 302 located within the larger geospatial location 301 can be used by the regulatory module 118 to filter out inapplicable regulations based on the location data. In some cases, the regulations may be the same for each of the multiple disturbance sites within a larger geospatial location. However, in other cases, there may be regulations imposed at the local level that will only be applicable to those disturbance sites within the locality. In these cases, the specific geospatial information of each disturbance site 302 provides the next level of filtering for the regulatory module 118 to filter out inapplicable regulations based on the precise location of the disturbance site. In essence, the modules 118-120 immediately begin interpreting the data to create a dynamic backdrop on which the system 100 operates.

The disturbance site 302 is the precise location, contained within the broader geospatial location 301, where the oil and gas operation is located. The map 400 displays the disturbance site 302 and sets the outermost disturbance limits 302a, which define the boundary of the disturbance. The spatial features at the disturbance site 302 are contained within the disturbance limits 302a. The geospatial information is unique for each disturbance site 301. Additionally, a unique location ID may be assigned to each disturbance site 302. The location ID may come from historical records or be newly assigned to the site. Thus, assigning the location ID to each disturbance site 302 can ease future regulatory reporting requirements where such ID had been relied upon in the past, and provides for familiarity and consistency between the expert system 100 and historical records and regulatory reports.

Contained within the disturbance site limits 302a are all the spatial features representing the assets present at the real-world oil and gas operation. The geospatial information for each spatial feature data entry defines the precise location of the feature within the disturbance site limits 302a. The shape information (e.g., point, line or polygon) for each spatial feature data entry allows the PostGIS extension 117 to provide geometric attributes to the feature on the map 400.

The asset data structure 300 categorizes spatial features based on the type of asset the features falls within. For example, the asset data structure 300 includes a lines category 306, a well machinery category 308 and an infrastructure category 310. Each asset category 308, 308 and 310 generates an asset layer in the map 400 that includes all spatial features falling within that category. The map 400 displays these asset layers as a single, common asset layer mapped over the appropriate assets.

For instance, in the example illustrated in FIGS. 3-4, the geospatial information for the secondary containment 334 spatial feature sets the feature in the southwest corner of the disturbance site 302, which corresponds to its actual location in the real-world. The shape information stored under the geospatial information for secondary containment 334 feature would be listed as a “polygon” which allows the PostGIS extension 117 to provide the geometric attributes to the feature rendering its final form, as shown on map 400.

Continuing with the secondary containment 334 example, tabular feature data entries, such as output 348 from the operational module 120 can be crosslinked to the spatial feature 334. The output 348 informs the operator of a need tied to the secondary containment 334 feature. In the illustrated example, the output 348 is an identified maintenance need. By crosslinking the output 348 with the spatial feature 334 in the data structure 300, the map 400 spatially represents the output 348 proximate to spatial feature 334, e.g., the system 100 can place an icon, such as a triangle, close to or on top of the spatial feature to inform a user viewing the map there is some outstanding need tied to that spatial feature. For example, map 400 indicates a need by placing output 348 near the secondary containment 334 feature. An operator of the system 100 can view the output 348 by selecting the icon, e.g., the triangle in the illustrative map 400, to view details on the output 348 which informs the operator of, for example, a maintenance need at spatial feature 334. With this information, a field operator at the disturbance site 302 can readily identify, locate and fulfill the outstanding maintenance work required for spatial feature 334 based on the details provided in output 348. Upon fulfillment, the operator can update the system 100 to indicate fulfilment, which will thereafter remove the maintenance need 348 from the map 400. Information on the fulfillment can be stored within the overall system to maintain accurate records of work completed at the disturbance site 302.

FIG. 5a is a first view of one example of an interactive user interface 500 according to aspects of the present invention. The interactive user interface 500 presents the data stored in system 100 in a workable and user friendly manner. The user interface 500 presents an interactive map of the disturbance site 502 with the spatial features mapped thereon. The disturbance site 502 includes all things above and below ground within the limits of the bolded line 502, delineating the outer limits of the disturbance site. The interactive user interface 500 includes a display window 520 and a tab window 522. The display window 520 is populated with the map 524 representing the digital twin of the asset data structure, e.g., the map 400 populates display window 520 as a digital twin of the asset data structure 300.

The tab window 522 of the user interface 500 includes a legend 504 to inform the user of the meaning of the various symbols and lines displayed on the map. For instance, each icon 501 indicated on the interface 500 informs the user that there is a “pipeline point” that is a “riser” at that exact position. The user can thereafter select that point to view additional attribute information by clicking on an icon 501 in the display window 520 of the user interface 500. For instance, when a user manipulates their cursor to select or “click” on the point 506, a secondary display window 508 (FIG. 5b) pops up. The secondary display window 508 presents the attribute information for the selected spatial feature. The information presented in the display window 508 will depend on the feature selected, as will be explained in more detail below.

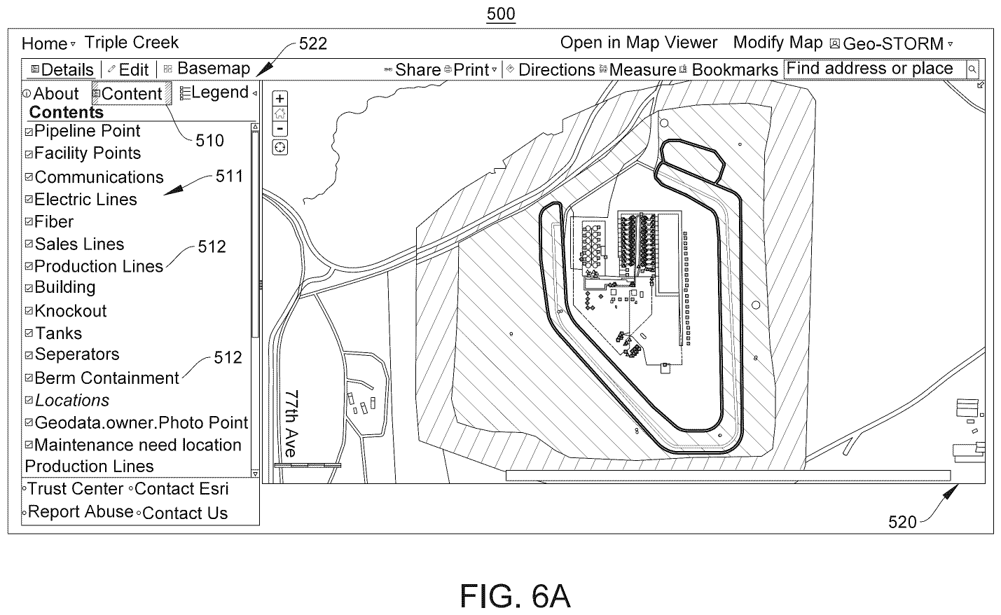

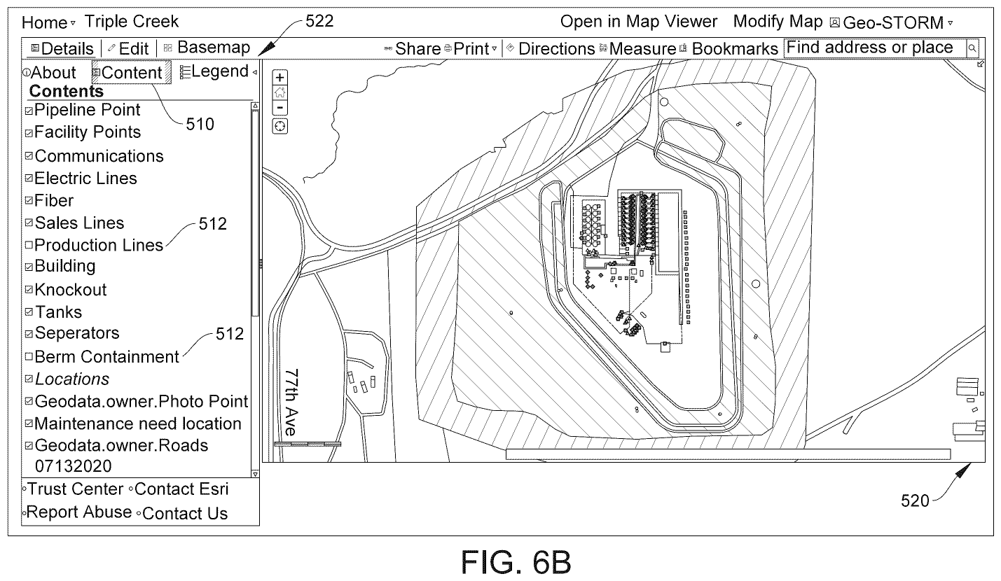

The user interface 500 also has content filtering means 510 (FIGS. 6a-6b) accessible in the tab window 522. The content filtering means 510 allows the user to customize the view of the user interface 500 by turning off or on certain asset categories 511. Specifically, the content filtering means 510 will inform the map 524 populating the display window 520. The asset categories 511 correspond to the spatial data entries 202 and tabular data entries 204 for the asset data structure 200. The content filtering means 510 can be a simple check box 512 that allows the user to turn on and off the selected assets based on category type 511. For instance, in FIG. 6a, all asset categories 511 have been selected, meaning the display window 520 of the interface 500 displays all the spatial and tabular features entered into the system 100 for that specific disturbance site 502. The user can deselect certain categories, e.g., production lines and berm containment, by deselecting those asset categories 511 using the content filtering means 510. By deselecting certain asset categories 511, the system 100 removes the asset layer of those features from the display window 520. The asset categories 511 that remain selected are mapped into the common asset layer to present the map 524 in the display window 520. As can be seen in FIG. 6b, a user has deselected “production lines” and “berm containment” using the content filtering means 510 so the display window 520 no longer maps the spatial features, i.e., assets, falling under either of those categories. Compare FIG. 6a, which shows an outline representing the “berm containment” spatial features and numerous lines representing “production lines,” with FIG. 6b which no longer presents these features in the display window 520.

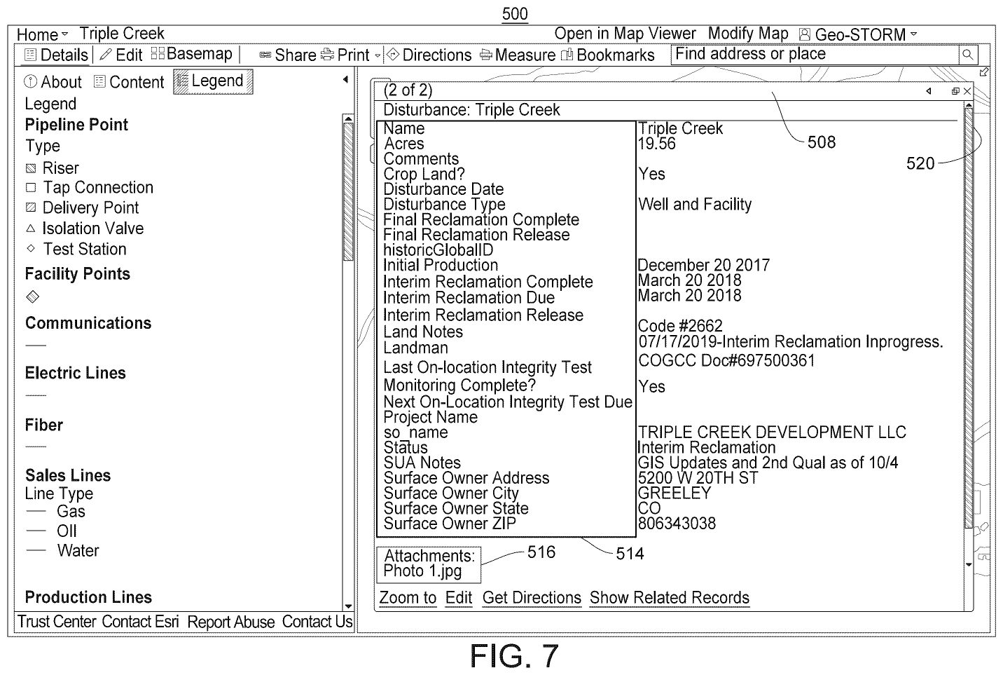

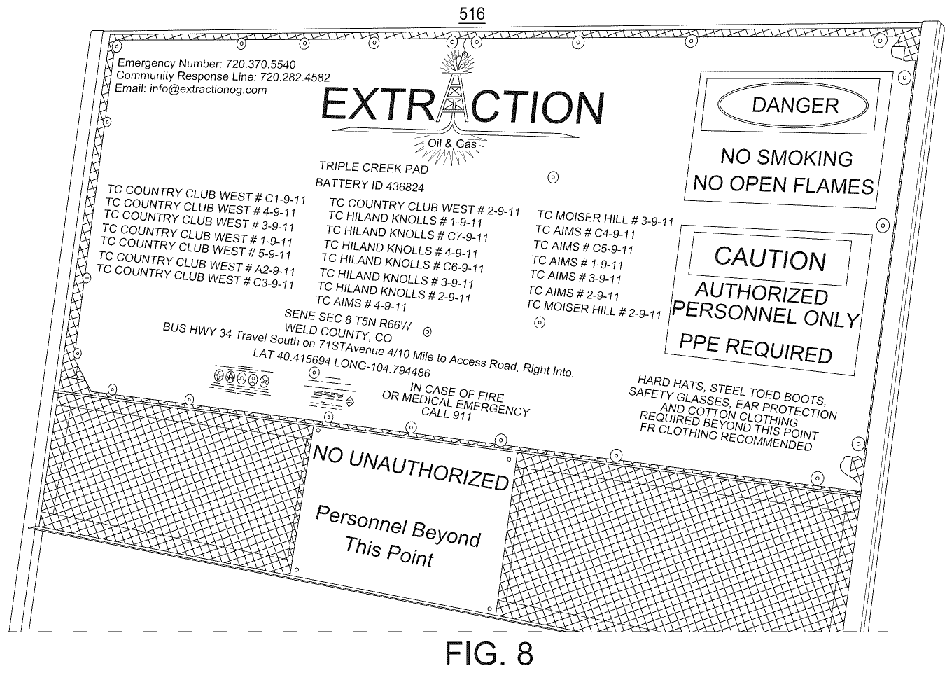

FIG. 7 is another exemplary view of a secondary display screen 508 accessible via the user interface 500. The secondary display screen 508 presents the user in the display window 520 with the attribute information 514 for a selected feature. The attribute information 514 is dependent on the feature selected. For instance, the feature selected in FIG. 7 is the disturbance site 502 and thus the attribute information 514 provides the user with information about the overall site, including ownership and location of the site, type of operation (e.g., disturbance), and other information that is applicable to the entire location. The display window also informs a user of any attachments 516 that have been linked to that feature. The attachments 516 may be any type of multimedia attachment, such as a photo or video. For instance, the attachment 516 attached to the disturbance site 502 in the secondary display window 508 features a photograph of the operator's identification sign (FIG. 8) that would be found at the entrance of the site and has useful information pertaining to the operation as well as emergency contact information.

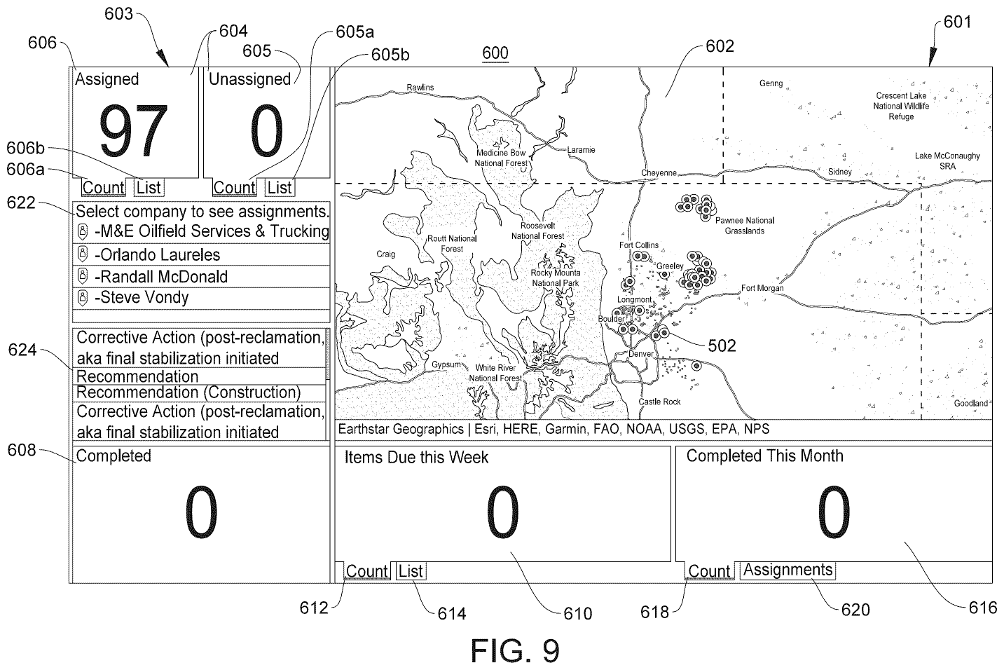

FIG. 9 is a first exemplary view of an operator interface according to the present invention. The operator interface 600 has an operator map 602 that populates an operator display window 601. The operator map 602 displays one or more disturbance sites 502 that are controlled by a common operator for a given geospatial location. Note, the map 602 of FIG. 9 is zoomed out significantly such that all the disturbance sites 502 owned by a single operator can be viewed. The operator display 600 also includes an assignment window 603 for assigning and tracking the progress for various workorders 604, e.g., maintenance need 348 from the above example, from the one or more modules 118 to 120. The operator interface 600 filters the workorders 604 based on whether the operator has assigned the workorder to a field worker. For instance, in the operator interface 600 displayed in FIG. 9, there have been ninety-seven assigned workorders 606 and zero unassigned workorders 605.

The operator interface 600 also displays a number of total completed workorders 608. For any workorders 604 that must be completed within a specific time or by a certain date, the operator interface 600 has a time sensitive workorder display 610. In the example provided in FIG. 9, the time sensitive workorder display 610 is set to a weekly reporting basis, i.e., “Items Due this Week.” An operator may change the reporting basis to a larger or smaller timeframe depending on the specific needs. The time sensitive workorder display 610 includes a count option 612 and a list option 614. When the count option 612 is selected, the time sensitive workorder display 610 informs the operator of the total number of workorders 604 that are due within the set timeframe. When the list option 614 is selected, the time sensitive workorder display 610 will present a list of all the workorders 604 that are due within the set timeframe.

The operator interface 600 also has a monthly reporting display 616 that can alternate between a monthly count 618 and a monthly assignment 620. The monthly count 618 merely shows the total number of workorders 604 that have been completed in the timeframe set whereas the monthly assignment 620 provides a list of the completed workorders 604 within the same set timeframe.

In another aspect of the operator interface 600, there is a means for filtering the workorders 604 displayed on the operator map 602. In one variation, the filtering means 622 can be based on the field worker to whom a workorder 604 is assigned. For example, using the field worker filtering means 622, an operator can select “M&E Oilfield Services & Trucking” which causes the operator map 602 to display all the disturbance sites 502 with a workorder 604 assigned to M&E Oilfield Services & Trucking. In another variation, the filtering means 624 can be based on the type of activity involved in the workorder, e.g., maintenance need, inspection, corrective action, etc. For example, an operator can select a “Corrective Action (post-reclamation, aka final stabilization initiated)” filtering option and the operator map 602 will display all corresponding workorders 604 that involve that type of activity, regardless of which field worker has been assigned the workorder. In preferred embodiments, the operator interface 600 includes both the field worker filtering means 622 and the activity type filtering means 624. Further, the filtering means 622 and 624 preferably function cooperatively so that an operator can use both filtering means at the same time to arrive at the desired results.

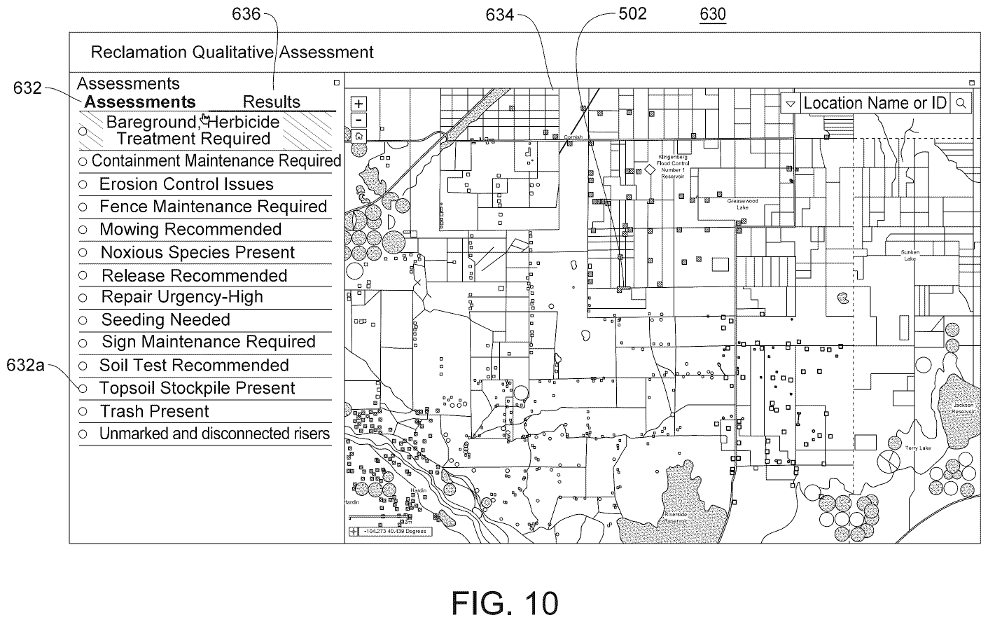

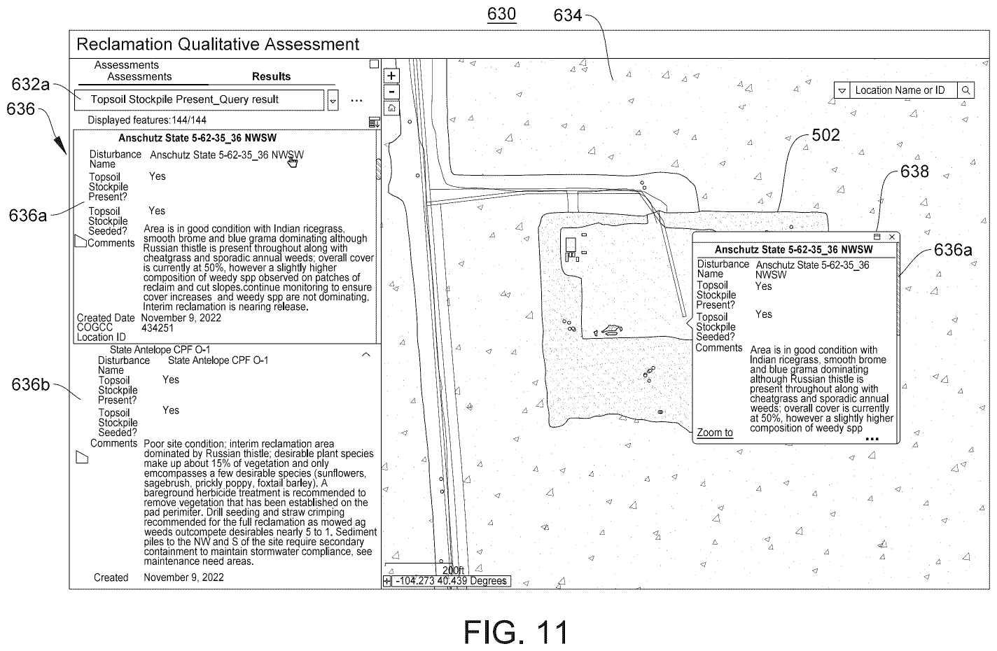

FIG. 10 is a first exemplary view of an assessment display interface that may be accessed via the operator interface 600. The assessment display interface 630 can display one or more outputs from the modules 118 to 120. The assessments display 630 provides a tabulated list of assessment types 632 and a map 634 for displaying one or more disturbance sites 502 for a given geospatial location that are controlled by a common operator. An operator can select one of the assessment types 632 from the tabulated list which will then present the operator with results 636 for the selected assessment type 632 directly in the listing. FIG. 11 is a second view of the assessment display interface 630 after selection of an assessment type 632 has been made. The results 636 displays a listing of all the completed assessments for the selected assessment type 632 for each of the various disturbance sites 502 controlled by the operator. For example, in FIG. 11 an operator has selected the “Topsoil Stockpile Present” assessment type 632a which will produce a list of all the results 636 responsive to that assessment type. From the results list 636, the operator can thereafter select an individual result 636a from the list which will cause the map 634 to zoom in to the disturbance site 502 for the selected result 636a. Information regarding the selected result 636a will be displayed as a listing in the results 636 and in a popup display window 638 in the map 634 over the disturbance site 502 pertaining to the selected result. If the operator changes selection, e.g., selects the result 636b, the map 634 will change its view to the disturbance site 502 that is linked to result 636b. In this manner, an operator can easily switch between results 636 responsive to the selected assessment type 632 with the map 634 continuously updating to display the disturbance site 502 corresponding to the selected result.

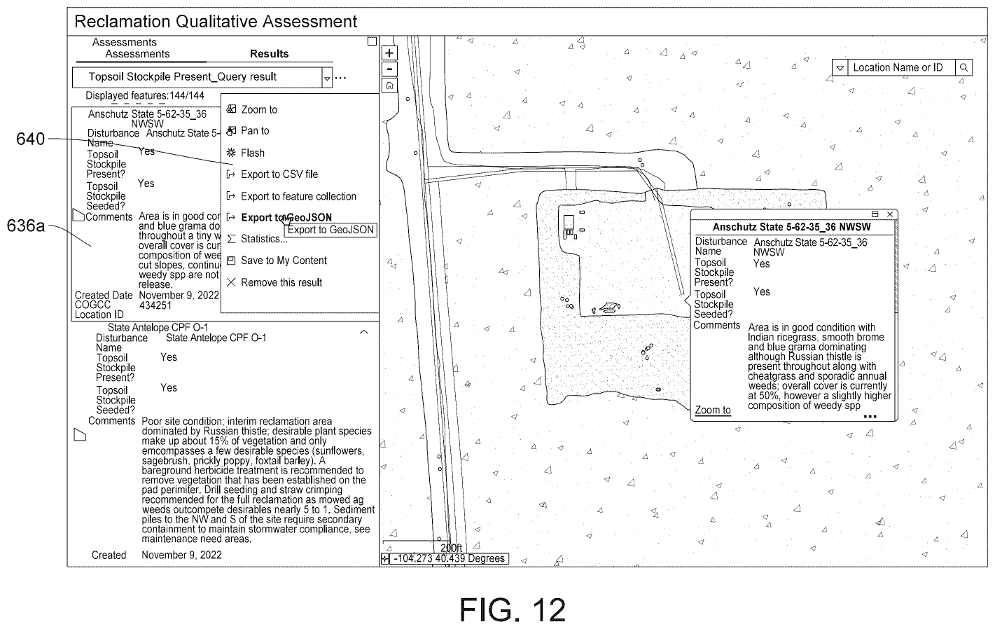

FIG. 12 is a further alternative view of the assessment display after selection of a result. An operator can click on the result 636a, which causes a functions window 640 to pop up. The functions window 640 offers the operator various functionalities to select from, such as exporting the individual result 636a as a geographic JavaScript object syntax (“GeoJSON”) file or comma-separated values (“CSV”) file. JSON is a conventional text-based format for representing structured data based on JavaScript object syntax. JSON is conventionally used for transmitting data in web applications (e.g., transmitting data from the server to the client so it can be displayed on a web page, or vice versa).

In further embodiments of the expert system 100, a rating system may be implemented with the assessment results 636. In this manner, an operator can send out daily reports if the results of a particular assessment indicate a low or falling quality at the disturbance site or any other type of ongoing performance failure at the disturbance site resulting a low grade assessment.

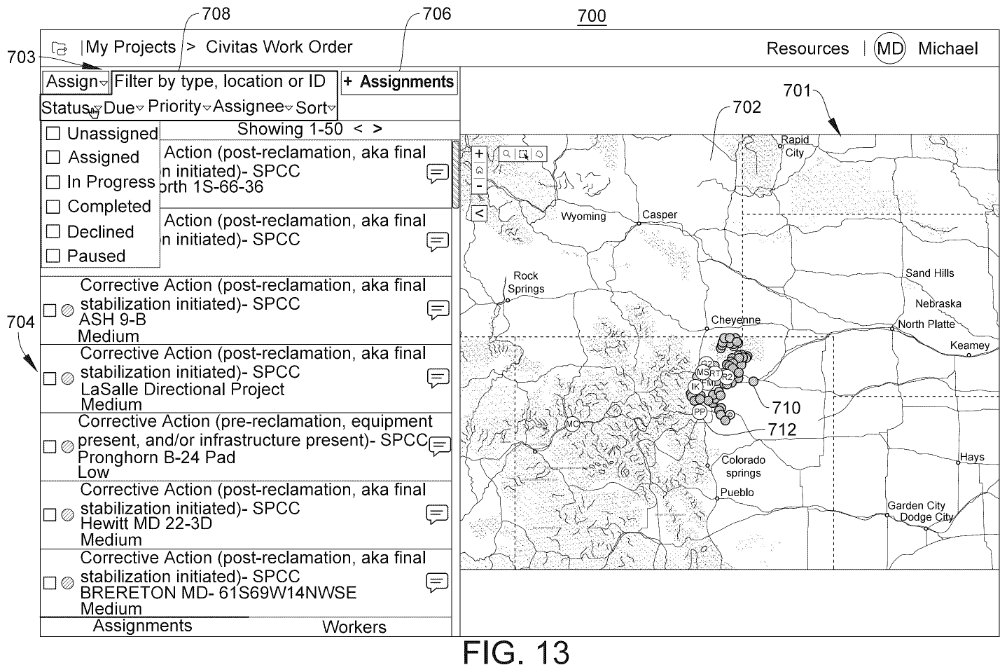

FIG. 13 is a first exemplary view of an assignment interface according to the present invention. The assignment interface 700 includes a display window 701 and a tabulated window 703. The display window 701 is populated with a map 702 and the tabulated window 703 includes an assignment list 704. The assignment interface 700 has means to create new assignments 706. The interface 700 also has means for an operator to filter the active assignments 708 in the tabulated assignments list 704. The assignment filtering means 708 can allow an operator to filter the active assignments based on a variety of different characteristics, e.g., status, due date, assignee, priority of assignment, etc. The map 702 displays the active assignments 710 and the active field workers 712 at that time. For instance, each solid circle on the map 702 represents an active assignment 710 while each circle containing initials represents an active field worker 712 at that location. In this manner, an operator can send out assignments to the various field workers based on their current proximity to the disturbance site that requires work.

When an operator has successfully created an assignment through the assignment interface 700, the operator interface 600 updates automatically to include the newly created assignment. In this manner, the assignment interface 700 and the operator interface 600 cooperate together. Further, to the extent an end user has been assigned one or more assignments, the interactive user interface 500 will display the assignment, e.g., output 348, proximate to a corresponding spatial feature depending on the details provided by the operator when creating the assignment.

While many of the inventive concepts have been described herein in relation to oil and gas operations, the inventive concepts as a whole are not limited to any one particular industry. The inventive concepts disclosed herein are equally applicable to other industries that may have a “living” infrastructure tied to a specific geospatial location. For example, the disclosed inventive concepts could be applied to a database constructed for a power plant, chemical processing plant or other type of infrastructure projects that is subject to ongoing regulatory compliance in an everchanging regulatory scheme.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A database management system for assets of an oil and gas operation, the system comprising:
a server in data communication with a computing device over a network, the computing device having an interactive user interface; and
memory stored in the server and accessible by the computing device, wherein asset data is stored in the memory and retrievable by the computing device, the asset data comprising:
geospatial information defining at least one disturbance site and spatial feature information representing one or more assets within the disturbance site;
wherein the interactive user interface displays a digital twin of the at least one disturbance site.

2. The system of claim 1, wherein the interactive user interface comprises a display window and a tab window, wherein the digital twin populates the display window.

3. The system of claim 2, wherein the spatial feature information is categorized by asset type, the categories of asset types populating the tab window as selectable categories.

4. The system of claim 3, wherein selection of any one category the selectable categories causes the display window to update the digital twin by mapping an asset layer, wherein the asset layer includes all assets defined within the selected category and located at the disturbance site.

5. The system of claim 4, wherein selection of multiple of the selectable categories causes the display window to update the digital twin by mapping an asset layer for each selected category, wherein the display window is populated with a common asset layer that combines the asset layer for each category to appear as a single asset layer.

6. The system of claim 1, further comprising a regulatory module stored in the memory and accessible by the computing device, wherein the regulatory module is configured to generate an output based on the asset data and display the output in the interactive user interface.

7. The system of claim 6, wherein the regulatory module comprises a means for filtering regulations based on location.

8. The system of claim 7, wherein the regulation filtering means interprets the geospatial information to determine a precise location of the disturbance site and pulls, from the memory, regulations only applicable to the precise location.

9. The system of claim 8, wherein the asset data further comprises attribute information representing the one or more assets within the disturbance site, wherein the attribute information corresponds to nonspatial information of the one or more assets.

10. The system of claim 9, wherein the regulatory module interprets the attribute information against the applicable regulations to produce the output.

11. The system of claim 10, further comprising tabular feature information stored in the memory and accessible by the computing device, wherein the tabular feature information is linkable to the spatial feature information.

12. The system of claim 11, wherein the output from the regulatory module is stored as tabular feature information that is linked to the spatial feature information.

13. The system of claim 12, wherein the interactive user interface displays the output in the digital twin as a selectable icon mapped over an asset with which the output has been linked.

14. The system of claim 1, wherein the asset data further comprise attribute information representing the one or more assets within the disturbance site, wherein the attribute information corresponds to nonspatial features of the one or more assets.

15. The system of claim 14, further comprising an operational module stored in the memory and accessible by the computing device, wherein the operational module is configured to interpret the attribute information of the one or more assets to generate an operator output.

16. The system of claim 15, wherein the operator output comprises a maintenance schedule for a subset of assets possessing common attribute information, wherein the maintenance schedule is generated based on the common attribute information.

17. The system of claim 1, wherein the memory further comprises a plurality of asset data entries, each of the plurality of asset data entries comprising geospatial information representing a unique disturbance site and spatial feature information representing one or more assets located within each unique disturbance site.

18. The system of claim 17, wherein the interactive user interface further comprises an operator display that generates an operator map displaying a digital twin for each unique disturbance site.

19. The system of claim 18, wherein each digital twin is selectable within the operator map and wherein upon selection of a digital twin, the interactive user interface displays only the selected digital twin.

20. The system of claim 1, wherein the memory comprises a tiered server, wherein each tier has a means for authenticating a user which limits access to manipulate the asset data.
